(19) United States
(12) Patent Application Publication
(10) Pub. No.: US 2016/0320609 A1
(43) Pub. Date: Nov. 3, 2016

(54) DRIVING APPARATUS

(71) Applicants: PIONEER CORPORATION, Kanagawa (JP); PIONEER MICRO TECHNOLOGY CORPORATION, Yamanashi (JP)

(72) Inventor: Mitsuru KOARAI, Yamanashi (JP)

(21) Appl. No.: 15/106,512

(22) PCT Filed: Dec. 20, 2013
(86) PCT No.: PCT/JP13/84363

§ 371 Date: Jun. 20, 2016

(51) Int. Cl. G02B 26/08; H02K 33/16; G02B 26/10

(52) U.S. Cl. CPC G02B 26/0833; G02B 26/101; H02K 33/16

(57) ABSTRACT

A driving apparatus (101) is provided with: a first base part (111); a second base part (112); a third base part (113); a first elastic part (122) that connects the first base part and the second base part; a second elastic part (124) that connects the second base part and the third base part; a first driven part (131) that is supported by the first base part to be driven; and a second driven part (132) that is supported by the third base part to be driven.

### TECHNICAL FIELD

The present invention relates to a driving apparatus such as, for example, a MEMS scanner for driving a driven part such as a mirror or a stage.

### BACKGROUND ART

In various technical fields such as, for example, a display, a printing apparatus, precision measurement, precision processing, and information recording-reproduction, research on a micro electro mechanical system (MEMS) device that is manufactured by a semiconductor fabrication technology is actively progressing. As the MEMS device as described above, a driving apparatus (what we call, an optical scanner or a MEMS scanner) that is capable of driving a driven part (for example, a mirror) to form an image by scanning a predetermined screen area with a light from a light source is known (for example, see a Patent Literature 1). Alternatively, as the MEMS device as described above, a driving apparatus (what we call, a MEMS actuator) that is capable of driving a driven part (for example, a stage) in a planar direction is known (for example, see a Patent Literature 2). Moreover, not only the MEMS scanner or the MEMS actuator, but also a driving apparatus that is capable of driving any driven object is known as one example of the MEMS device.

### CITATION LIST

### Patent Literature

Patent Literature 1: Japanese Unexamined Patent Application Publication No. 2008-139886

Patent Literature 2: WO 2011/061831

### SUMMARY OF INVENTION

### Technical Problem

The above described Patent Literatures 1 and 2 disclose the driving apparatus in which a plurality of driven parts are supported by one base (alternatively, frame). In contrast with these conventional driving apparatus, it is an object of the present invention to provide a driving apparatus that is capable of driving a plurality of driven parts in new aspect.

### Solution to Problem

In order to solve the above object, the driving apparatus is provided with: a first base part; a second base part; a third base part; a first elastic part that connects the first base part and the second base part; a second elastic part that connects the second base part and the third base part; a first driven part that is supported by the first base part to be driven; and a second driven part that is supported by the third base part to be driven.

### BRIEF DESCRIPTION OF DRAWINGS

FIG. 1 is a plan/side view illustrating a structure of a MEMS scanner in a first example

FIG. 2 are a plan view and a side view illustrating an aspect of a rotational operation of a first mirror and a second mirror around an X axis

FIG. 3 are a plan view and a side view illustrating an aspect of the rotational operation of the first mirror and the second mirror around the X axis.

FIG. 4 are a plan view and a side view illustrating an aspect of the rotational operation of the first mirror and the second mirror around a Y axis.

FIG. 5 are a plan view and a side view illustrating an aspect of the rotational operation of the first mirror and the second mirror around the Y axis.

### DESCRIPTION OF EMBODIMENT

Hereinafter, an explanation will be given to an embodiment of the driving apparatus in order.

<1>

A driving apparatus in the present embodiment is provided with: a first base part; a second base part; a third base part; a first elastic part that connects the first base part and the second base part; a second elastic part that connects the second base part and the third base part; a first driven part that is supported by the first base part to be driven; and a second driven part that is supported by the third base part to be driven.

According to the driving apparatus in the present embodiment, the first base part is directly or indirectly connected to (in other words, coupled with) the second baser part by the first elastic part (for example, a torsion bar described later or the like) having elasticity. Here, since the first elastic part has the elasticity, it is preferable that stiffness of the first elastic part be smaller than stiffness (stiffnesses) of both of or one of the first base part and the second base part. In other words, it is preferable that a shape of the first elastic part can be changed more easily than shape (shapes) of both of or one of the first base part and the second base part. In other words, it is preferable that the shape of the first elastic part can be changed relatively easily and the shape (shapes) of both of or one of the first base part and the second base part cannot be changed relatively easily.

Moreover, according to the driving apparatus in the present embodiment, the second base part is directly or indirectly connected to (in other words, coupled with) the third baser part by the second elastic part (for example, a torsion bar described later or the like) having elasticity. Here, since the first elastic part has the elasticity, it is preferable that stiffness of the second elastic part be smaller than stiffness (stiffnesses) of both of or one of the second base part and the third base part. In other words, it is preferable that a shape of the second elastic part can be changed more easily than shape (shapes) of both of or one of the second base part and the third base part. In other words, it is preferable that the shape of the second elastic part can be changed relatively easily and the shape (shapes) of both of or one of the second base part and the third base part cannot be changed relatively easily.

The first base part supports the first driven part. In this case, the first base part supports the first driven part to allow the first driven part to be driven (for example, to rotate or to move). For example, the first base part is connected to the first driven part by an elastic part having elasticity and thus the first base part may support the first driven part to allow the first driven part to be driven.

The third base part supports the second driven part. In this case, the third base part supports the second driven part to allow the second driven part to be driven (for example, to rotate or to move). For example, the third base part is connected to the second driven part by an elastic part having elasticity and thus the third base part may support the second driven part to allow the second driven part to be driven.

The driving apparatus in the present embodiment having the above described structure is capable of driving (for example, rotating or moving) each of the first driven part and the second driven part appropriately. Namely, according to the driving apparatus in the present embodiment having the above described structure, each of the first driven part and the second driven part is capable of being driven (for example, rotating or moving) appropriately. Specifically, when the second base part moves, the first base part that is connected to the second base part by the first elastic part also moves due to the movement of the second base part. When the first base part moves, the first driven part that is supported by the first base part also moves due to the movement of the first base part. Similarly, when the second base part moves, the third base part that is connected to the second base part by the second elastic part also moves due to the movement of the second base part. When the third base part moves, the second driven part that is supported by the third base part also moves due to the movement of the third base part. As a result, each of the first driven part and the second driven part is capable of being driven appropriately.

Incidentally, from a viewpoint of appropriately driving the first driven part, the first base part may be connected to the second baser part by a structure other than the first elastic part (for example, a structure not having the elasticity or not having a character of changing its shape more easily than the first base part and the second base part). Similarly, the second base part may be connected to the third baser part by a structure other than the second elastic part (for example, a structure not having the elasticity or not having a character of changing its shape more easily than the second base part and the third base part). Even in this case, each of the first driven part and the second driven part is capable of being driven due to the movement of the second base part.

<2>

In another aspect of the driving apparatus in the present embodiment, the driving apparatus is further provided with: an applying device that applies, to the second base part, a driving force for driving the first driven part and the second driven part, the first driven part is driven by the driving force that is transmitted from the second base part via the first elastic part, the second driven part is driven by the driving force that is transmitted from the second base part via the second elastic part.

According to this aspect, the second base part moves by the driving force that is applied to the second base part. When the second base part moves, the first base part and the third base part that are connected to the second base part also move. When the first base part and the third base part move, the first driven part and the second driven part move. Thus, the first driven part and the third driven part is capable of being driven by the driving force that is applied to the second base part (namely, the driving force that is substantially transmitted from the second base part via the first elastic part or the second elastic part).

<3>

In another aspect of the driving apparatus in the present embodiment, the driving apparatus is further provided with: an applying device that applies, to the second base part, a driving force for driving the first driven part and the second driven part, the second base part is driven to rotate in a first rotational direction by the driving force, each of the first base part and the third baser part is driven to rotate in a second rotational direction that is opposite to the first rotational direction due to the rotation of the second base part, the first driven part is driven to rotate in the second rotational direction due to the rotation of the first base part, the second driven part is driven to rotate in the second rotational direction due to the rotation of the third base part.

According to this aspect, the second base part rotates (namely, moves) in the first rotational direction due to the driving force that is applied to the second base part. When the second base part rotates, the first base part and the third base part that are connected to the second base part also rotate (namely, move) as described later in detail by using drawings. At this time, since the first base part is connected to the second base part by the first elastic part having the elasticity, the rotational direction of the first base part is the second rotational direction opposite to the first rotational direction that is the rotational direction of the second baser part. Similarly, since the third base part is connected to the second base part by the second elastic part having the elasticity, the rotational direction of the third base part is the second rotational direction opposite to the first rotational direction that is the rotational direction of the second baser part. When the first base part and the third base part rotate in the second rotational direction, the first driven part and the second driven part also rotate (namely, move) in the second rotational direction. Thus, the first driven part and the second driven part are capable of being driven to appropriately rotate by the driving force that is applied to the second base part (namely, the driving force that is substantially transmitted from the second base part via the first elastic part or the second elastic part).

<4>

In another aspect of the driving apparatus in the present embodiment, the first driven part and the second driven part are driven in a same or synchronized driving aspect.

According to this aspect, a plurality of driven parts (namely, the first driven part and the second driven part) of the driving apparatus are capable of being driven in the same or the synchronized driving aspect.

Incidentally, the above described same or synchronized driving aspect in which the first driven part and the second driven part are driven may be realized by the structure (for example, an adjustment of the structure) of the driving apparatus. Namely, the driving apparatus may have a structure by which the first driven part and the second driven part are capable of being driven in the same or synchronized driving aspect. The above described same or synchronized driving aspect in which the first driven part and the second driven part are driven may be realized by the driving force (for example, an adjustment of an aspect of applying the driving force) for driving the first driven part and the second driven part. Namely, the driving apparatus may be provided with an applying device that applies a driving force for driving the first driven part and the second driven part in the same or synchronized aspect.

When the same or synchronized driving aspect in which the first driven part and the second driven part are driven is realized by the structure of the driving apparatus, for example, the first base part, the second base part and the third base part may be arranged to allow the first base part and the third base part to sandwich the second base part along a first direction (for example, a direction that is along a virtual plane at which the first base part, the second base part and the third base part are located, and a direction that is along surfaces of the static first driven part and the static second driven part). In this case, the first elastic part may connect the first base part and the second base part to allow the first base part and the second base part to be arranged along the first direction, and the second elastic part may connect the second base part and the third base part to allow the second base part and the third base part to be arranged along the first direction. Moreover, in this case, the first driven part may be connected to the first base part via a third elastic part extending along a second direction that crosses with (preferably, is perpendicular to) the first direction, and the second driven part may be connected to the third base part via a fourth elastic part extending along the second direction. Moreover, the first base part, the second base part and the third base part may be arranged to allow the first base part and the third base part to be arranged at symmetrical positions with the second base part being a center of the symmetry.

<5>

In another aspect of the driving apparatus in the present embodiment, the first driven part and the second driven part are driven to rotate in same rotational direction by same rotational angle in synchronization with each other.

According to this aspect, the plurality of driven parts (namely, the first driven part and the second driven part) of the driving apparatus are capable of being driven in the same or the synchronized driving aspect.

These operation and other advantages in the present embodiment will become more apparent from the examples explained below.

As explained above, the driving apparatus in the present embodiment is provided with: the first base part; the second base part; the third base part; the first elastic part; the second elastic part; the first driven part; and the second driven part. Therefore, the driving apparatus is capable of driving the plurality of driven parts in new aspect.

### Examples

Hereinafter, with reference to the drawings, example of the driving apparatus of the present invention will be explained. Incidentally, hereinafter, an example in which the driving apparatus of the present invention is applied to a MEMS scanner will be explained. However, it goes without saying that the driving apparatus of the present invention can be applied to any driving apparatus other than the MEMS scanner.

(1) Basic Structure

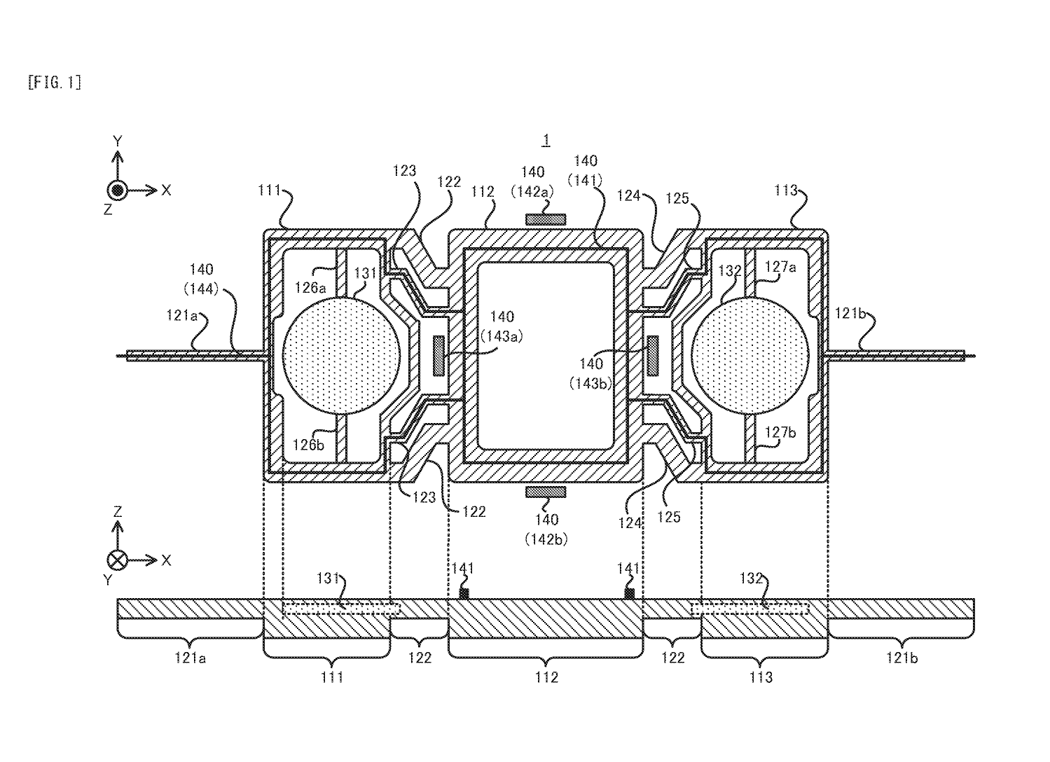

Firstly, with reference to FIG. 1, a basic structure of the MEMS scanner 1 in the present example will be explained. FIG. 1 is a plan/side view illustrating the basic structure of the MEMS scanner 1 in the present example

As illustrated in FIG. 1, the MEMS scanner 1 in the present example is provided with: a first frame 111 that is one example of the “first base part”; a second frame 112 that is one example of the “second base part”; a third frame 113 that is one example of the “third base part”; torsion bars 121a and 121b for X axis driving; first torsion bars 122 for connection each of which is one example of the “first elastic part”; first torsion bars 123; for wiring; second torsion bars 124 for connection each of which is one example of the “second elastic part”; second torsion bars 125 for wiring; first torsion bars 126a and 126b for Y axis driving; second torsion bars 127a and 127b for Y axis driving; a first mirror 131; a second mirror 132; and a driving source part 140.

The first frame 111 has a frame shape having a space therein. Namely, the first frame 111 has a frame shape (namely, a frame shape that is arranged on a XY surface) that has two sides extending along a Y axis direction in FIG. 1 and two sides extending along a X axis direction (i.e. a direction perpendicular to the Y axis direction) in FIG. 1 and that has a space surrounded by the two sides extending along the Y axis direction and the two sides extending along the X axis direction. In an example illustrated in FIG. 1, the first frame 111 has a square shape (however, one portion of that shape curves in accordance with an outline of the first mirror 131 that is located in the space of the first frame 111). However, the first frame 111 may has another shape (for example, a circular shape or the like).

The second frame 112 also has a frame shape having a space therein, as with the first frame 111. In the example illustrated in FIG. 1, the second frame 112 has a square shape. However, the second frame 112 may has another shape, as with the first frame 111.

The third frame 113 also has a frame shape having a space therein, as with the first frame 111. In the example illustrated in FIG. 1, the third frame 113 has a square shape (however, one portion of that shape curves in accordance with an outline of the second mirror 132 that is located in the space of the third frame 113). However, the third frame 113 may has another shape, as with the first frame 111.

The first frame 111, the second frame 112 and the third frame 113 are arranged to allow the first frame 111, the second frame 112 and the third frame 113 to line in this order on a XY surface along the frame shape of each of the first frame 111, the second frame 112 and the third frame 113. The first frame 111, the second frame 112 and the third frame 113 are arranged to allow the first frame 111, the second frame 112 and the third frame 113 to line in this order along the X axis. However, the first frame 111, the second frame 112 and the third frame 113 may be arranged in another arranging aspect.

The first frame 111 and the third frame 113 have symmetrical shapes whose center is the second frame 112. For example, the first frame 111 and the third frame 113 may has point symmetrical shapes whose center (symmetrical point) is a center of the second frame 112 (for example, a center of the space of the second frame 112). For example, the first frame 111 and the third frame 113 may has line symmetrical shapes whose center (symmetrical axis) is a line that passes through the center of the second frame 112 and that is parallel to the Y axis. However, the first frame 111 and the third frame 113 may has asymmetrical shapes with respect to the second frame 112. The first frame 111 and the third frame 113 may have different shapes.

The first frame 111 and the third frame 113 may be arranged at symmetrical positions whose center is the second frame 112. For example, the first frame 111 and the third frame 113 may be arranged at point symmetrical positions whose center (symmetrical point) is the center of the second frame 112. For example, the first frame 111 and the third frame 113 may be arranged at line symmetrical positions whose center (symmetrical axis) is the line that passes through the center of the second frame 112 and that is parallel to the Y axis. However, the first frame 111 and the third frame 113 may be arranged at asymmetrical positions with respect to the second frame 112.

Each of the torsion bars 121a and 121b for X axis driving is a member having elasticity such as a spring made of silicone, copper alloy, iron-based alloy, other metal, resin, or the like, for example. Each of the torsion bars 121a and 121b for X axis driving is arranged to extend along the X axis. In other words, each of the torsion bars 121a and 121b for X axis driving has a shape having a long side extending along the X axis and a short side extending along the Y axis. One end of the torsion bar 121a for X axis driving is connected to an outer side of the first frame 111. One end of the torsion bar 121b for X axis driving is connected to an outer side of the third frame 113. The other end of each of the torsion bars 121a and 121b for X axis driving is connected to a structure (for example, a substrate or a supporting member that is not illustrated) that is a base of the MEMS scanner 1. Namely, a structure including the first frame 111, the second frame 112 and the third frame 113 is arranged to be suspended (hung) or supported by the torsion bars 121a and 121b for X axis driving. As a result, as described later, the structure including the first frame 111, the second frame 112 and the third frame 113 is capable of rotating (in other words, swinging) around the X axis by the elasticity of the torsion bars 121a and 121b for X axis driving.

Incidentally, as illustrated in a lower part of FIG. 1, a thickness (namely, a size along a thickness-direction or a Z axis) of each of the torsion bars 121a and 121b for X axis driving is smaller than a thickness of each of the first frame 111, the second frame 112 and the third frame 113. As a result, each of the torsion bars 121a and 121b for X axis driving is allowed to have the elasticity. However, the thickness of each of the torsion bars 121a and 121b for X axis driving may not be smaller than the thickness of each of the first frame 111, the second frame 112 and the third frame 113. Same is true in other torsion bars that will be explained later (namely, the first torsion bars 122 for connection, the first torsion bars 123 for wiring, the second torsion bars 124 for connection, the second torsion bars 125 for wiring, the first torsion bars 126a and 126b for Y axis driving and the second torsion bars 127a and 127b for Y axis driving).

The first torsion bar 122 for connection is a member having elasticity such as a spring made of silicone, copper alloy, iron-based alloy, other metal, resin, or the like, for example. The first torsion bar 122 for connection connects (in other words, couples) the first frame 111 and the second frame 112. Especially, the first torsion bar 122 for connection connects the first frame 111 and the second frame 112 to allow the first frame 111 and the second frame 112 to line along the X axis. Thus, it is preferable that at least one portion of the first torsion bar 122 for connection have a shape extending along the X axis.

It is preferable that stiffness of the first torsion bar 122 for connection be smaller than stiffness of each of the first frame 111 and the second frame 112, because the first torsion bar 122 for connection has the elasticity. Namely, it is preferable that a shape of the first torsion bar 122 for connection can be changed more easily than the shape of each of the first frame 111 and the second frame 112. However, the stiffness of the first torsion bar 122 for connection may not be smaller than (for example, may be same as or larger than) the stiffness of each of the first frame 111 and the second frame 112.

Incidentally, the first frame 111 and the second frame 112 may be a structure that is substantially unified via the first torsion bars 122 for connection. In this case, the first frame 111, the second frame 112 and the first torsion bars 122 for connection may be distinguished in the unified structure on the basis of the stiffness of each structural part of the unified structure. For example, the structural part of the unified structure whose stiffness is relatively large may be distinguished as the first frame 111 and the second frame 112 and the structural part of the unified structure whose stiffness is relatively small (namely, that has the elasticity) may be distinguished as the first torsion bars 122 for connection.

Moreover, FIG. 1 illustrates an example in which the first frame 111 and the second frame 112 are connected by two first torsion bars 122 for connection. However, the first frame 111 and the second frame 112 may be connected any number of (for example, one, three or more) first torsion bar (bars) 122 for connection.

The first torsion bar 123 for wiring is a member having elasticity such as a spring made of silicone, copper alloy, iron-based alloy, other metal, resin, or the like, for example. The first torsion bar 123 for wiring is different from the first torsion bar 122 for connection in that a wiring 144 for supplying driving current to below described coil 141 is formed on the first torsion bar 123 for wiring and the wiring 144 is not formed on the first torsion bar 122 for connection. Another characteristics of the first torsion bar 123 for wiring may be same as those of the first torsion bar 122 for connection.

Incidentally, FIG. 1 illustrates an example in which the first frame 111 and the second frame 112 are connected by two first torsion bars 123 for wiring. However, the first frame 111 and the second frame 112 may be connected any number of (for example, one, three or more) first torsion bar (bars) 123 for wiring.

Moreover, the MEMS scanner 1 may not have the first torsion bars 123 for wiring. In this case, the wiring 144 may be formed on the first torsion bars 122 for connection.

The second torsion bar 124 for connection is a member having elasticity such as a spring made of silicone, copper alloy, iron-based alloy, other metal, resin, or the like, for example. The second torsion bar 124 for connection connects (in other words, couples) the second frame 112 and the third frame 113. Especially, the second torsion bar 124 for connection connects the second frame 112 and the third frame 113 to allow the second frame 112 and the third frame 113 to line along the X axis. Thus, it is preferable that at least one portion of the second torsion bar 124 for connection have a shape extending along the X axis.

It is preferable that stiffness of the second torsion bar 124 for connection be smaller than stiffness of each of the second frame 112 and the third frame 113, because the second torsion bar 124 for connection has the elasticity. Namely, it is preferable that a shape of the second torsion bar 124 for connection can be changed more easily than the shape of each of the second frame 112 and the third frame 113. However, the stiffness of the second torsion bar 124 for connection may not be smaller than (for example, may be same as or larger than) the stiffness of each of the second frame 112 and the third frame 113.

Incidentally, the second frame 112 and the third frame 113 may be a structure that is substantially unified via the second torsion bars 124 for connection. In this case, the second frame 112, the third frame 113 and the second torsion bars 124 for connection may be distinguished in the unified structure on the basis of the stiffness of each structural part of the unified structure. For example, the structural part of the unified structure whose stiffness is relatively large may be distinguished as the second frame 112 and the third frame 113 and the structural part of the unified structure whose stiffness is relatively small (namely, that has the elasticity) may be distinguished as the second torsion bars 124 for connection.

Moreover, FIG. 1 illustrates an example in which the second frame 112 and the third frame 113 are connected by two second torsion bars 124 for connection. However, the second frame 112 and the third frame 113 may be connected any number of (for example, one, three or more) second torsion bar (bars) 124 for connection.

The second torsion bar 125 for wiring is a member having elasticity such as a spring made of silicone, copper alloy, iron-based alloy, other metal, resin, or the like, for example. The second torsion bar 125 for wiring is different from the second torsion bar 124 for connection in that the wiring 144 for supplying the driving current to the below described coil 141 is formed on the second torsion bar 125 for wiring and the wiring 144 is not formed on the second torsion bar 124 for connection. Another characteristics of the second torsion bar 125 for wiring may be same as those of the second torsion bar 124 for connection.

Incidentally, FIG. 1 illustrates an example in which the second frame 112 and the third frame 113 are connected by two second torsion bars 125 for wiring. However, the second frame 112 and the third frame 113 may be connected any number of (for example, one, three or more) second torsion bar (bars) 125 for wiring.

Moreover, the MEMS scanner 1 may not have the second torsion bars 125 for wiring. In which case, the wiring 144 may be formed on the second torsion bars 124 for connection.

Each of the first torsion bars 126a and 126b for Y axis driving is a member having elasticity such as a spring made of silicone, copper alloy, iron-based alloy, other metal, resin, or the like, for example. Each of the first torsion bars 126a and 126b for Y axis driving is arranged to extend along the Y axis. In other words, each of the first torsion bars 126a and 126b for Y axis driving has a shape having a long side extending along the Y axis and a short side extending along the X axis. One end of each of the first torsion bars 126a and 126b for Y axis driving is connected to an inner side of the first frame 111. The other end of each of the first torsion bars 126a and 126b for Y axis driving is connected to an outer side of the first mirror 131. Namely, the first mirror 131 is arranged to be suspended (hung) or supported by the first torsion bars 126a and 126b for Y axis driving. As a result, as described later, the first mirror 131 is capable of rotating (in other words, swinging) around the Y axis by the elasticity of the first torsion bars 126a and 126b for Y axis driving.

Each of the second torsion bars 127a and 127b for Y axis driving is a member having elasticity such as a spring made of silicone, copper alloy, iron-based alloy, other metal, resin, or the like, for example. Each of the second torsion bars 127a and 127b for Y axis driving is arranged to extend along the Y axis. In other words, each of the second torsion bars 127a and 127b for Y axis driving has a shape having a long side extending along the Y axis and a short side extending along the X axis. One end of each of the second torsion bars 127a and 127b for Y axis driving is connected to an inner side of the third frame 113. The other end of each of the second torsion bars 127a and 127b for Y axis driving is connected to an outer side of the second mirror 132. Namely, the second mirror 132 is arranged to be suspended (hung) or supported by the second torsion bars 127a and 127b for Y axis driving. As a result, as described later, the second mirror 132 is capable of rotating (in other words, swinging) around the Y axis by the elasticity of the second torsion bars 127a and 127b for Y axis driving.

The first mirror 131 is a disk-shaped member on surface of which a reflective film is formed. However, the first mirror 131 may be a member having any shape (for example, a plate-shape) other than the disk-shape. The first mirror 131 reflects light that enters the first mirror 131 from an external light source. At this time, since the first mirror 131 is capable of rotating around the Y axis, the first mirror 131 is capable of performing a light scanning (namely, scan).

The second mirror 132 is a disk-shaped member on surface of which a reflective film is formed. However, the second mirror 132 may be a member having any shape (for example, a plate-shape) other than the disk-shape. The second mirror 132 reflects light that enters the second mirror 132 from an external light source. At this time, since the second mirror 132 is capable of rotating around the Y axis, the second mirror 132 is capable of performing a light scanning (namely, scan).

Incidentally, the light that enters the first mirror 131 may be same as the light that enters the second mirror 132. The light source for the light that enters the first mirror 131 may be same as the light source for the light that enters the second mirror 132. For example, when the MEMS scanner 1 is used as a display (for example, a Head-Up Display), a video (alternatively, an image, same is true in the following explanation) that is generated by the light entering the first mirror 131 may be same as the video that is generated by the light entering the second mirror 132. In this case, if both of the light that enters the first mirror 131 and the light that enters the second mirror 132 are projected on same screen, brightness of the projected video can be increased than that of the video generated by a MEMS scanner having single mirror.

Alternatively, the light that enters the first mirror 131 may be different from the light that enters the second mirror 132. The light source for the light that enters the first mirror 131 may be different from the light source for the light that enters the second mirror 132. For example, when the MEMS scanner 1 is used as the display (for example, the Head-Up Display), the video that is generated by the light entering the first mirror 131 may be different from the video that is generated by the light entering the second mirror 132. In this case, the MEMS scanner 1 in the present example is capable of simultaneously projecting different videos. Therefore, the MEMS scanner 1 in the present example can be used as one of a device for realizing a multi-display system.

The driving source part 140 applies, to the second frame 112, a driving force that is needed for each of the first mirror 131 and the second mirror 132 to rotate around each of the X axis and the Y axis. Incidentally, as long as the driving source part 140 is capable of applying the driving force to the second frame 112, the driving source part 140 may be arranged at any position.

In the present example, the driving source part 140 is a driving source part that applies, to the second frame 112, the driving force caused by electromagnetic force. Thus, the driving source part 140 is provided with: the coil 141 that is arranged along the frame shape of the second frame 112; magnets 142a and 142b for X axis driving by which the second frame 112 is sandwiched along the X axis; magnets 143a and 143b for Y axis driving by which the second frame 112 is sandwiched along the Y axis; and the wiring 144 that is for supplying the driving current to the coil 141. Incidentally, a detail of the operation of the driving source part 140 will be described later.

However, the driving source part 140 may be a driving source part that applies any driving force (for example, a driving force cause by piezoelectric effect or a driving force caused by electrostatic force) other than the driving force caused by the electromagnetic force. Moreover, the driving source part 140 may be a driving source part that applies the driving force to a structure (for example, the first frame 111 or the third frame 113) other than the second frame 112.

Incidentally, the structure of the MEMS scanner 1 illustrated in FIG. 1 is one example Therefore, as long as the MEMS scanner 1 is provided with: at least three frames that are connected via a torsion bar (torsion bars); and at least two mirror that are supported by at least two frames of these at least three frames, the structure of the MEMS scanner 1 may be modified. In other words, as long as the MEMS scanner 1 is a structure having at least three structural parts whose stiffness is relatively large and that are connected or unified via a structural part (structural parts) whose stiffness is relatively small (namely, that has elasticity) and at least two structural parts of these at least three structural parts support at least two mirrors, the structure of the MEMS scanner 1 may be modified.

(2) Operation of MEMS Scanner

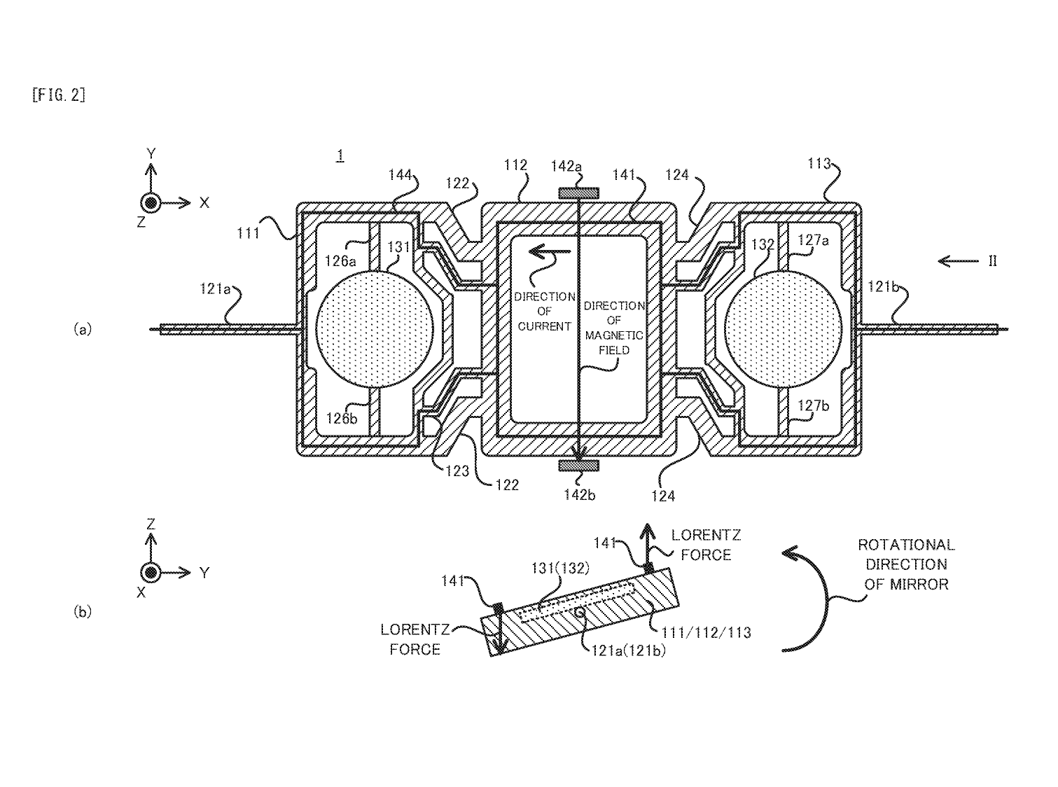

Next, with reference to FIG. 2 to FIG. 5, an aspect of an operation of the MEMS scanner 1 in the present example (specifically, an aspect of a rotational operation of the first mirror 131 and the second mirror 132) will be explained. Incidentally, hereinafter, each of the rotational operation of the first mirror 131 and the second mirror 132 around the X axis and the rotational operation of the first mirror 131 and the second mirror 132 around the Y axis will be explained in order.

(2-1) Rotational Operation of First Mirror 131 and Second Mirror 132 Around X Axis

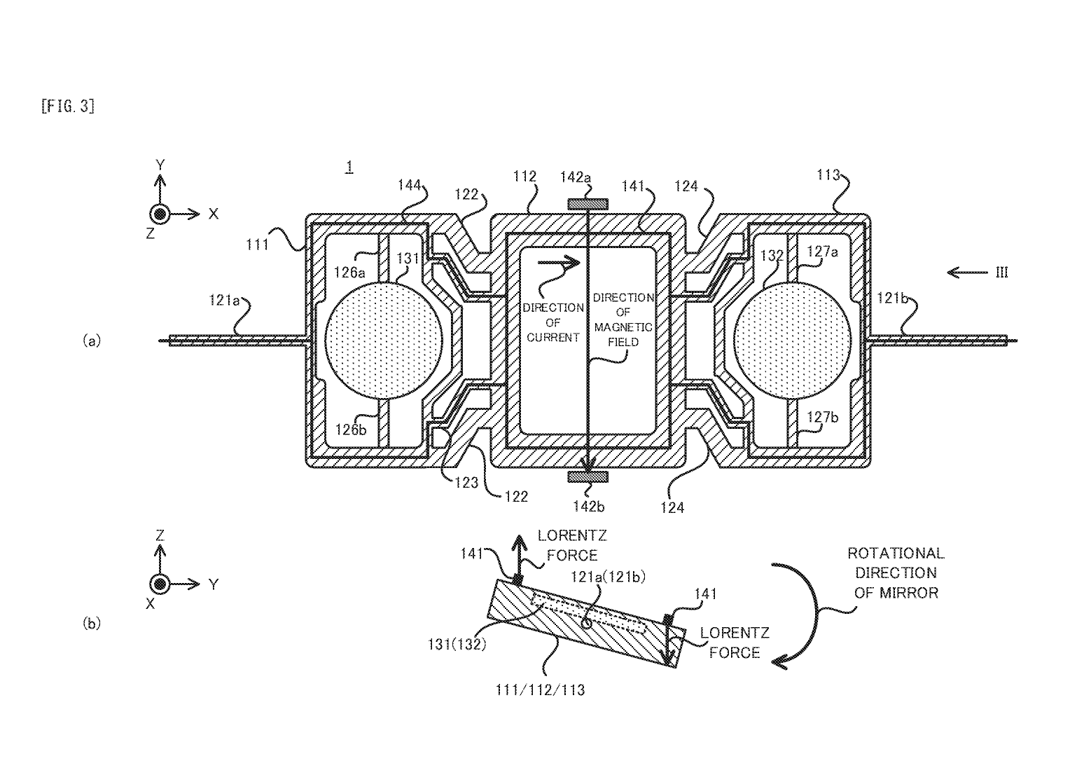

Firstly, with reference to FIG. 2 to FIG. 3, the aspect of the rotational operation of the first mirror 131 and the second mirror 132 around the X axis will be explained. Each of FIG. 2 to FIG. 3 are a plan view and a side view illustrating the aspect of the rotational operation of the first mirror 131 and the second mirror 132 around the X axis.

When the MEMS scanner 1 operates, the desired driving current is supplied to the coil 141 at a desired timing from non-illustrated circuit for controlling the driving source part via the wiring 144. The driving current includes a current component for rotating each of the first mirror 131 and the second mirror 132 around the X axis. Hereinafter, the current component for rotating each of the first mirror 131 and the second mirror 132 around the X axis is referred to as a “current component for X axis driving”.

In the present example, each of the first mirror 131 and the second mirror 132 rotates around the X axis at any frequency (for example, 60 Hz). In this case, it is preferable that the current component for X axis driving include an alternate current whose frequency is same as the frequency at which each of the first mirror 131 and the second mirror 132 rotate around the X axis. However, the current component for X axis driving may include an alternate current including a signal component whose frequency is synchronized with (for example, is N (wherein, N is an integer) times or 1/N times of) the frequency at which each of the first mirror 131 and the second mirror 132 rotate around the X axis.

For example, when the MEMS scanner 1 is used as the display (alternatively, the Head-Up Display), each of the first mirror 131 and the second mirror 132 may rotate around the X axis at a frequency (for example, 60 Hz) based on a scanning frequency or a frame rate of the display. In this case, it is preferable that the current component for X axis driving includes alternate current whose frequency is 60 Hz.

However, each of the first mirror 131 and the second mirror 132 may rotate around the X axis at a resonance frequency that is determined on the basis of the torsion bars 121a and 121b for X axis driving and a suspended part (specifically, a structure including the first frame 111, the second frame 112, the third frame 113, the first torsion bars 122 for connection, the first torsion bars 123 for wiring, the second torsion bars 124 for connection, the second torsion bars 125 for wiring, the first torsion bars 126a and 126b for Y axis driving, the second torsion bars 127a and 127b for Y axis driving, the first mirror 131 and the second mirror 132) that is suspended by the torsion bars 121a and 121b for X axis driving. Specifically, each of the first mirror 131 and the second mirror 132 may rotate around the X axis at the resonance frequency that is determined on the basis of a torsion spring constant of the torsion bars 121a and the 121b for X axis driving and an inertia moment around the X axis of the suspended part that is suspended by the torsion bars 121a and 121b for X axis driving. More specifically, for example, if the torsion spring constant of the torsion bars 121a and the 121b for X axis driving on the assumption that the torsion bars 121a and 121b for X axis driving are regarded as one spring is kx and the inertia moment around the X axis of the suspended part that is suspended by the torsion bars 121a and 121b for X axis driving is Ix, each of the first mirror 131 and the second mirror 132 may rotate around the X axis to resonate at the resonance frequency that is determined by (1/(2π))×√(kx/Ix) (alternatively, the resonance frequency that is N times or 1/N times of (1/(2π))×√(kx/Ix)).

On the other hand, magnetic field is applied from the magnets 142a and 142b for X axis driving to the coil 141. Hereinafter, the magnetic field that is applied from the magnets 142a and 142b for X axis driving is referred to as a “magnetic field for X axis driving”. In this case, it is preferable that the magnets 142a and 142b for X axis driving apply the magnetic field for X axis driving to two sides of the coil 141 that face to each other along the Y axis (namely, two sides of coil 141 each of which extends along the X axis). In other words, it is preferable that the magnets 142a and 142b for X axis driving apply the magnetic field for X axis driving that crosses with the two sides of the coil 141 that face to each other along the Y axis. However, the magnets 142a and 142b for X axis driving may apply the magnetic field for X axis driving in another aspect.

Therefore, a Lorentz force due to an electromagnetic interaction between the current component for X axis driving that is supplied to the coil 141 and the magnetic field for X axis driving that is applied to the coil 141 is generated at the coil 141.

Here, as illustrated in FIG. 2(a), a situation where the current component for X axis driving flowing along a counterclockwise direction in FIG. 2(a) is supplied to the coil 141 and the magnetic field for X axis driving reaching from the magnet 142a for X axis driving to the magnet 142b for X axis driving is applied to the coil 141 will be explained. In this case, as illustrated in FIG. 2(b) that is a drawing obtained by observing the MEMS scanner 1 illustrated in FIG. 2(a) from a direction of an arrow II, the Lorentz force that acts toward a upward direction in FIG. 2(b) is generated at a right side (namely, an upper side in FIG. 2(a)) of the two sides of the coil 141 that face to each other along the Y axis. Similarly, as illustrated in FIG. 2(b), the Lorentz force that acts toward a downward direction in FIG. 2(b) is generated at a left side (namely, a lower side in FIG. 2(a)) of the two sides of the coil 141 that face to each other along the Y axis. Namely, the Lorentz forces that act toward different directions are generated at the two sides of the coil 141 that face to each other along the Y axis. In other words, the Lorentz forces that are a couple of force are generated at the two sides of the coil 141 which face to each other along the Y axis. Therefore, the coil 141 rotates toward the counterclockwise direction in FIG. 2(b).

On the other hand, as illustrated in FIG. 3(a), a situation where the current component for X axis driving flowing along a clockwise direction in FIG. 3(a) is supplied to the coil 141 and the magnetic field for X axis driving reaching from the magnet 142a for X axis driving to the magnet 142b for X axis driving is applied to the coil 141 follows after the situation illustrated in FIG. 2(a), because the current component for X axis driving is the alternate current. In this case, as illustrated in FIG. 3(b) that is a drawing obtained by observing the MEMS scanner 1 illustrated in FIG. 3(a) from a direction of an arrow III, the Lorentz force that acts toward the downward direction in FIG. 3(b) is generated at the right side (namely, the upper side in FIG. 3(a)) of the two sides of the coil 141 that face to each other along the Y axis. Similarly, as illustrated in FIG. 3(b), the Lorentz force that acts toward the upward direction in FIG. 3(b) is generated at the left side (namely, the lower side in FIG. 3(a)) of the two sides of the coil 141 that face to each other along the Y axis. Namely, the Lorentz forces that act toward different directions are generated at the two sides of the coil 141 that face to each other along the Y axis. In other words, the Lorentz forces that are a couple of force are generated at the two sides of the coil 141 which face to each other along the Y axis. Therefore, the coil 141 rotates toward the clockwise direction in FIG. 3(b).

The Lorentz force allows the coil 141 to rotate (more specifically, repeats a reciprocating operation of the rotation) around the X axis (more specifically, around the torsion bars 121a and 121b for X axis driving each of which extends along the X axis). As a result, the second base 112 on which the coil 141 is formed also rotates around the X axis due to the rotation of the coil 141 around the X axis.

Here, as described above, in the present example, the first frame 111 is connected to the second frame 112 via the first torsion bars 122 for connection and the third frame 113 is connected to the second frame 112 via the second torsion bars 124 for connection. Therefore, the first frame 111 and the third frame 113 also rotate around the X axis due to the rotation of the second frame 112 around the X axis. At this time, the first frame 111, the second frame 112 and the third frame 113 rotate around the X axis as if the first frame 111, the second frame 112 and the third frame 113 are one structure. Namely, the first frame 111, the second frame 112 and the third frame 113 rotate around the X axis toward same rotational direction by same rotational angle.

Moreover, as described above, in the present example, the first mirror 131 is connected to the first frame 111 via the first torsion bars 126a and 126b for Y axis driving. Therefore, the first mirror 131 also rotate around the X axis due to the rotation of the first frame 111 around the X axis.

Similarly, as described above, in the present example, the second mirror 132 is connected to the third frame 113 via the second torsion bars 127a and 127b for Y axis driving. Therefore, the second mirror 132 also rotate around the X axis due to the rotation of the third frame 113 around the X axis.

Here, as described above, the first frame 111, the second frame 112 and the third frame 113 rotate around the X axis toward same rotational direction by same rotational angle. Therefore, the first mirror 131 and the second mirror 132 rotate such that the rotational direction around the X axis of the first mirror 131 is same as the rotational direction around the X axis of the second mirror 132. In addition, the first mirror 131 and the second mirror 132 rotate such that a rotational angle around the X axis of the first mirror 131 (for example, a rotational angle of a surface of the driven first mirror 131 with respect to the surface of the static first mirror 131) is same as a rotational angle around the X axis of the second mirror 132. Namely, the first mirror 131 and the second mirror 132 rotates around the X axis in synchronization with each other.

(2-2) Rotational Operation of First Mirror 131 and Second Mirror 132 Around Y Axis

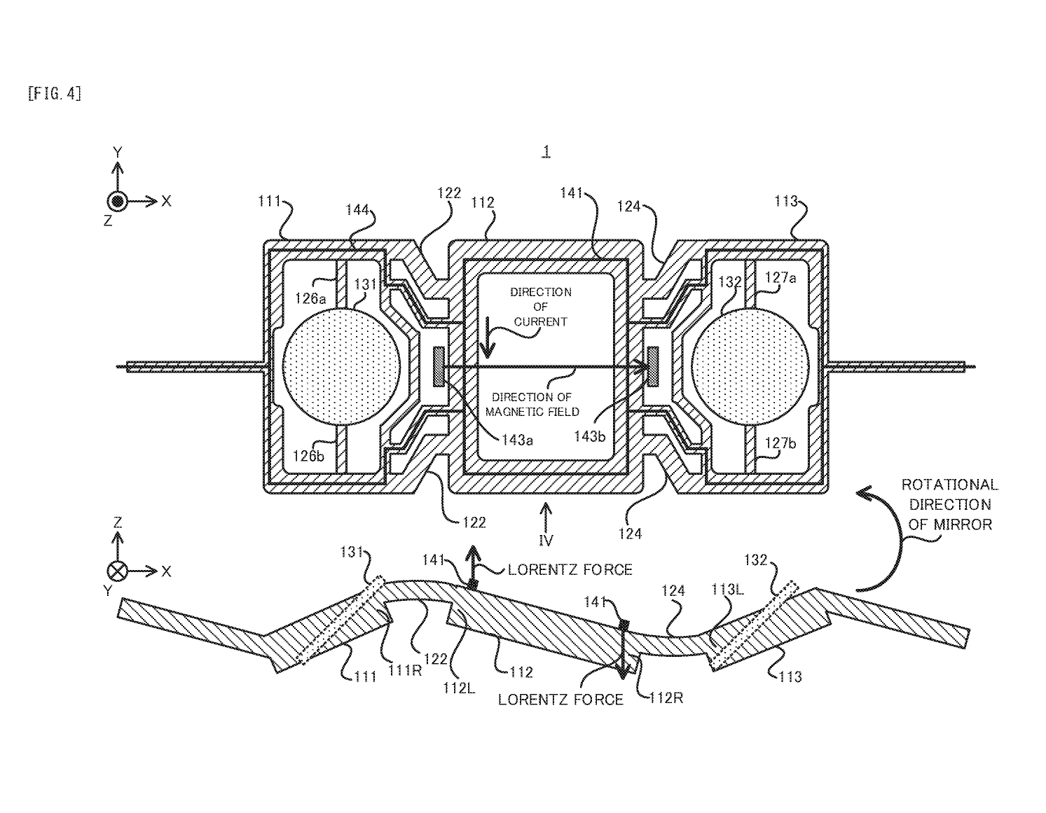

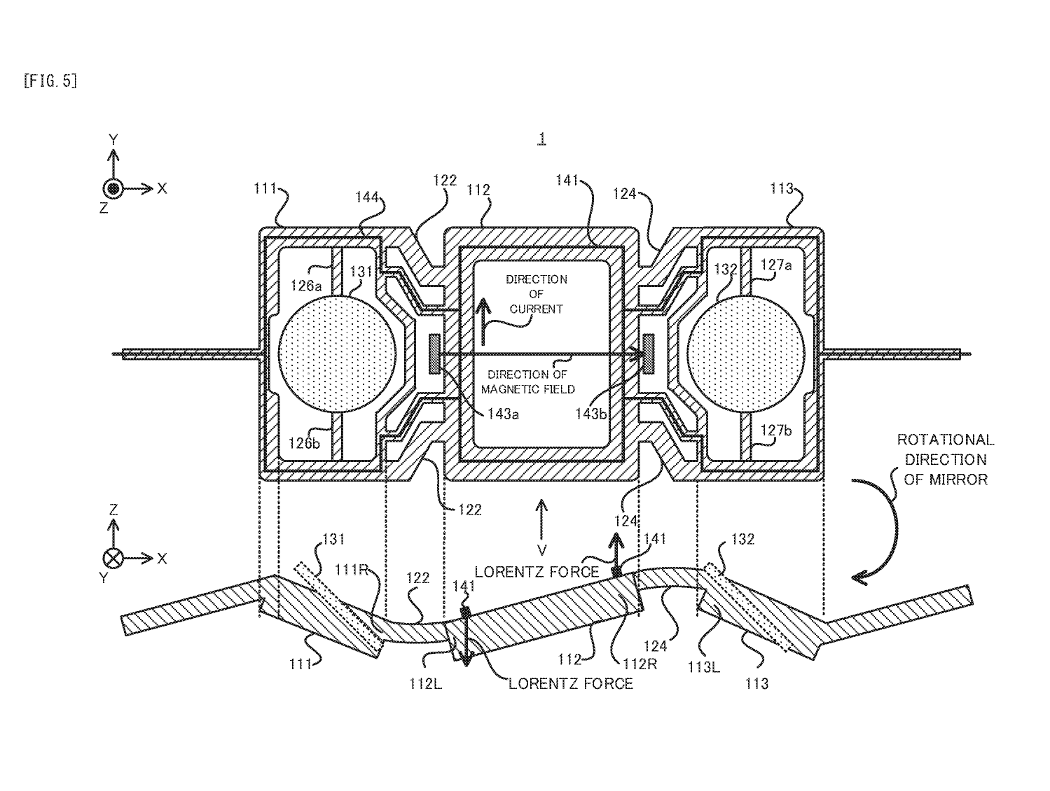

Next, with reference to FIG. 4 to FIG. 5, the aspect of the rotational operation of the first mirror 131 and the second mirror 132 around the Y axis will be explained. Each of FIG. 4 to FIG. 5 are a plan view and a side view illustrating the aspect of the rotational operation of the first mirror 131 and the second mirror 132 around the Y axis.

As described above, the driving current is supplied to the coil 141. The driving current includes a current component for rotating each of the first mirror 131 and the second mirror 132 around the Y axis, in addition to the above described current component for X axis driving. Hereinafter, the current component for rotating each of the first mirror 131 and the second mirror 132 around the Y axis is referred to as a “current component for Y axis driving”.

In the present example, the first mirror 131 rotates around the Y axis at a resonance frequency that is determined on the basis of the first mirror 131 and the first torsion bars 126a and 126b for Y axis driving. Specifically, the first mirror 131 rotates around the Y axis at the resonance frequency that is determined on the basis of an inertia moment around the Y axis of the first mirror 131 and a torsion spring constant of the first torsion bars 126a and the 126b for Y axis driving. More specifically, for example, if the inertia moment around the Y axis of the first mirror 131 is Iy1 and the torsion spring constant of the first torsion bars 126a and the 126b for Y axis driving on the assumption that the first torsion bars 126a and 126b for Y axis driving are regarded as one spring is ky1, the first mirror 131 rotates around the X axis to resonate at the resonance frequency that is determined by (1/(2π))×√(ky1/Iy1) (alternatively, the resonance frequency that is N times or 1/N times of (1/(2π))×√(ky1/Iy1)).

Similarly, the second mirror 132 rotates around the Y axis at a resonance frequency that is determined on the basis of the second mirror 132 and the second torsion bars 127a and 127b for Y axis driving. Specifically, the second mirror 132 rotates around the Y axis at the resonance frequency that is determined on the basis of an inertia moment around the Y axis of the second mirror 132 and a torsion spring constant of the second torsion bars 127a and the 127b for Y axis driving. More specifically, for example, if the inertia moment around the Y axis of the second mirror 132 is Iy2 and the torsion spring constant of the second torsion bars 127a and the 127b for Y axis driving on the assumption that the second torsion bars 127a and 127b for Y axis driving are regarded as one spring is ky2, the second mirror 132 rotates around the X axis to resonate at the resonance frequency that is determined by (1/(2π))×√(ky2/Iy2) (alternatively, the resonance frequency that is N times or 1/N times of (1/(2π))×√(ky2/Iy2)).

Incidentally, in the present example, it is preferable that the resonance frequency of the first mirror 131 be same as the resonance frequency of the second mirror 132.

Thus, it is preferable that characteristics (for example, shapes, sizes, arranged positions, materials and the like) of the first mirror 131, the second mirror 132, the first torsion bars 126a and 126b for Y axis driving and the second torsion bars 127a and 127b for Y axis driving be set accordingly to allow the resonance frequency of the first mirror 131 to be same as the resonance frequency of the second mirror 132. Typically, the characteristics of the first mirror 131 is same as the characteristics of the second mirror 132 and the characteristics of the first torsion bars 126a and 126b is same as the characteristics of the second torsion bars 127a and 127b.

However, each of the first mirror 131 and the second mirror 132 may rotate around the Y axis at any frequency.

On the other hand, magnetic field is applied from the magnets 143a and 143b for

Y axis driving to the coil 141. Hereinafter, the magnetic field that is applied from the magnets 143a and 143b for Y axis driving is referred to as a “magnetic field for Y axis driving”. In this case, it is preferable that the magnets 143a and 143b for Y axis driving apply the magnetic field for Y axis driving to two sides of the coil 141 that face to each other along the X axis (namely, two sides of coil 141 each of which extends along the Y axis). In other words, it is preferable that the magnets 143a and 143b for Y axis driving apply the magnetic field for Y axis driving that crosses with the two sides of the coil 141 that face to each other along the X axis. However, the magnets 143a and 143b for Y axis driving may apply the magnetic field for Y axis driving in another aspect.

Therefore, a Lorentz force due to an electromagnetic interaction between the current component for Y axis driving that is supplied to the coil 141 and the magnetic field for Y axis driving that is applied to the coil 141 is generated at the coil 141.

Here, as illustrated in FIG. 4(a), a situation where the current component for Y axis driving flowing along a counterclockwise direction in FIG. 4(a) is supplied to the coil 141 and the magnetic field for Y axis driving reaching from the magnet 143a for Y axis driving to the magnet 143b for Y axis driving is applied to the coil 141 will be explained. In this case, as illustrated in FIG. 4(b) that is a drawing obtained by observing the MEMS scanner 1 illustrated in FIG. 4(a) from a direction of an arrow IV, the Lorentz force that acts toward a downward direction in FIG. 4(b) is generated at a right side (namely, a right side also in FIG. 4(a)) of the two sides of the coil 141 that face to each other along the X axis. Similarly, as illustrated in FIG. 4(b), the Lorentz force that acts toward an upward direction in FIG. 4(b) is generated at a left side (namely, a left side also in FIG. 4(a)) of the two sides of the coil 141 that face to each other along the X axis. Namely, the Lorentz forces that act toward different directions are generated at the two sides of the coil 141 that face to each other along the X axis. In other words, the Lorentz forces that are a couple of force are generated at the two sides of the coil 141 which face to each other along the X axis. Therefore, the coil 141 rotates toward the clockwise direction in FIG. 4(b).

On the other hand, as illustrated in FIG. 5(a), a situation where the current component for Y axis driving flowing along a clockwise direction in FIG. 5(a) is supplied to the coil 141 and the magnetic field for Y axis driving reaching from the magnet 143a for Y axis driving to the magnet 143b for Y axis driving is applied to the coil 141 follows after the situation illustrated in FIG. 4(a), because the current component for Y axis driving is the alternate current. In this case, as illustrated in FIG. 5(b) that is a drawing obtained by observing the MEMS scanner 1 illustrated in FIG. 5(a) from a direction of an arrow V, the Lorentz force that acts toward the upward direction in FIG. 5(b) is generated at the right side (namely, the right side also in FIG. 5(a)) of the two sides of the coil 141 that face to each other along the X axis. Similarly, as illustrated in FIG. 5(b), the Lorentz force that acts toward the downward direction in FIG. 5(b) is generated at the left side (namely, the left side also in FIG. 5(a)) of the two sides of the coil 141 that face to each other along the X axis. Namely, the Lorentz forces that act toward different directions are generated at the two sides of the coil 141 that face to each other along the X axis. In other words, the Lorentz forces that are a couple of force are generated at the two sides of the coil 141 which face to each other along the X axis. Therefore, the coil 141 rotates toward the counterclockwise direction in FIG. 5(b).

The Lorentz force allows the coil 141 to rotate (more specifically, repeats a reciprocating operation of the rotation) around the Y axis. As a result, the second base 112 on which the coil 141 is formed also rotates around the Y axis due to the rotation of the coil 141 around the Y axis.

Here, as described above, in the present example, the first frame 111 is connected to the second frame 112 via the first torsion bars 122 for connection and the third frame 113 is connected to the second frame 112 via the second torsion bars 124 for connection. Therefore, the first frame 111 and the third frame 113 also rotate around the Y axis due to the rotation of the second frame 112 around the Y axis. However, rotational aspects around the Y axis of the first frame 111 and the third frame 113 are different from rotational aspects around the X axis of the first frame 111 and the third frame 113.

Specifically, as illustrated in FIG. 4(b), when a left side (hereinafter, it is referred to as a “left side 112L”) of two sides of the second frame 112 that face to each other along the X axis moves toward the upward direction, a right side (hereinafter, it is referred to as a “right side 111R”) of two sides of the first frame 111 that face to each other along the X axis direction also moves toward the upward direction, wherein the right side 111R is connected to the left side 112L. However, the first torsion bars 122 for connection, which connects the left side 112L of the second frame 112 and the right side 111R of the first frame 111, has the elasticity, and thus the shape of the first torsion bars 122 for connection can be changed, and thus whole of the first frame 111 does not move toward the upward direction. Therefore, as illustrated in FIG. 4(b), when the second frame 112 rotates toward the clockwise direction, the first frame 111 rotates toward the counterclockwise direction.

Similarly, as illustrated in FIG. 4(b), when a right side (hereinafter, it is referred to as a “right side 112R”) of the two sides of the second frame 112 that face to each other along the X axis moves toward the downward direction, a left side (hereinafter, it is referred to as a “left side 113L”) of two sides of the third frame 113 that face to each other along the X axis direction also moves toward the downward direction, wherein the left side 113L is connected to the right side 112R. However, the second torsion bars 124 for connection, which connects the right side 112R of the second frame 112 and the left side 113L of the third frame 113, has the elasticity, and thus the shape of the second torsion bars 124 for connection can be changed, and thus whole of the third frame 113 does not move toward the downward direction. Therefore, as illustrated in FIG. 4(b), when the second frame 112 rotates toward the clockwise direction, the third frame 113 rotates toward the counterclockwise direction.

On the other hand, as illustrated in FIG. 5(b), when the left side 112L of the second frame 112 moves toward the downward direction, the right side 111R of the first frame 111 also moves toward the downward direction. However, the first torsion bars 122 for connection, which connects the left side 112L of the second frame 112 and the right side 111R of the first frame 111, has the elasticity, and thus the shape of the first torsion bars 122 for connection can be changed, and thus whole of the first frame 111 does not move toward the downward direction. Therefore, as illustrated in FIG. 5(b), when the second frame 112 rotates toward the counterclockwise direction, the first frame 111 rotates toward the clockwise direction.

Similarly, as illustrated in FIG. 5(b), when the right side 112R of the second frame 112 moves toward the upward direction, the left side 113L of the third frame 113 also moves toward the upward direction. However, the second torsion bars 124 for connection, which connects the right side 112R of the second frame 112 and the left side 113L of the third frame 113, has the elasticity, and thus the shape of the second torsion bars 124 for connection can be changed, and thus whole of the third frame 113 does not move toward the upward direction. Therefore, as illustrated in FIG. 5(b), when the second frame 112 rotates toward the counterclockwise direction, the third frame 113 rotates toward the clockwise direction.

Considering the above described rotational aspects of the first frame 111, the second frame 112 and the third frame 113, it can be said that a structure including the first frame 111, the second frame 112, the third frame 113, the first torsion bars 122 for connection and the second torsion bars 124 for connection changes its shape to deform and vibrate along the X axis due to the rotation of the second frame 112 around the Y axis. Specifically, for example, it can be said that this structure changes its shape to deform and vibrate along the X axis in an aspect where each of the first torsion bars 122 for connection and the second torsion bars 124 for connection corresponds to an antinode of the vibration and vicinity of a center part along the X axis of each of the first frame 111, the second frame 112 and the third frame 113 corresponds to a node of the vibration. In other words, it can be said that this structure deforms and vibrates to bend at positions of the first torsion bars 122 for connection and the second torsion bars 124 for connection.

Summarizing the above described explanation, the rotation of the second frame 112 allows each of the first frame 111 and the third frame 113 to rotate around the Y axis toward the rotational direction that is opposite to the rotational direction of the second frame 112. At this time, the first frame 111 and the third frame 113 rotates around the Y axis by same rotational angle.

Moreover, as described above, in the present example, the first mirror 131 is connected to the first frame 111 via the first torsion bars 126a and 126b for Y axis driving. Therefore, the first mirror 131 also rotate around the Y axis due to the rotation of the first frame 111 around the Y axis.

Similarly, as described above, in the present example, the second mirror 132 is connected to the third frame 113 via the second torsion bars 127a and 127b for Y axis driving. Therefore, the second mirror 132 also rotate around the Y axis due to the rotation of the third frame 113 around the Y axis.

Here, as described above, the first frame 111 and the third frame 113 rotate around the Y axis toward same rotational direction by same rotational angle. Therefore, the first mirror 131 and the second mirror 132 rotate such that the rotational direction around the Y axis of the first mirror 131 is same as the rotational direction around the Y axis of the second mirror 132. In addition, the first mirror 131 and the second mirror 132 rotate such that the rotational angle around the Y axis of the first mirror 131 is same as the rotational angle around the Y axis of the second mirror 132. Namely, the first mirror 131 and the second mirror 132 rotates around the Y axis in synchronization with each other.

As described above, the MEMS scanner 1 in the present example is capable of rotating each of the first mirror 131 and the second mirror 132 around each of the X axis and the Y axis. Namely, the MEMS scanner 1 in the present example is capable of driving each of the first mirror 131 and the second mirror 132 in two axes.

Especially, in the MEMS scanner 1 in the present example, the plurality of frames that supports the plurality of mirrors (namely, the first mirror 131 and the second mirror 132), respectively, are arranged individually and the plurality of frames are connected via the torsion bars. Therefore, the MEMS scanner 1 in the present example is capable of rotating each of the plurality of mirrors (namely, the first mirror 131 and the second mirror 132) around each of the X axis and the Y axis appropriately or relatively easily.

In addition, the MEMS scanner 1 in the present example is capable of allowing the light that enters the first mirror 131 to be different from the light that enters the second mirror 132, and thus simultaneously projecting the plurality of different videos. Namely, the MEMS scanner 1 in the present example is capable of simultaneously projecting the plurality of different videos without causing increasing of a size and a cost of the MEMS scanner 1, in comparison with a case where the plurality of different videos are simultaneously projected by using a plurality of MEMS scanners each of which has single mirror.

Incidentally, the above described description explains the MEMS scanner 1 having two mirrors (namely, the first mirror 131 and the second mirror 132). However, the above described structure may be applied to a MEMS scanner having three or more mirrors.

Moreover, the above described description explains the MEMS scanner 1 that drives each of the first mirror 131 and the second mirror 132 in two axes. However, the MEMS scanner 1 may drives each of the first mirror 131 and the second mirror 132 in one axis. For example, the MEMS scanner 1 may rotate each of the first mirror 131 and the second mirror 132 around only one of the X axis and the Y axis. Moreover, the MEMS scanner 1 may drive each of the first mirror 131 and the second mirror 132 in a plurality of axes (for example, rotate the first mirror 131 and the second mirror 132 around three or more axes).

Moreover, the above described MEMS scanner 1 in the present example may be applied to various kinds of electrical device such as a Head-Up Display, a Head Mount Display, a laser scanner, a laser printer and a scanning type driving apparatus, for example Therefore, these electrical devices are includes in a scope of the present invention.

In the present invention, various changes may be made, if desired, without departing from the essence or spirit of the invention which can be read from the claims and the entire specification. A driving apparatus, which involves such changes, is also intended to be within the technical scope of the present invention.

### DESCRIPTION OF REFERENCE CODES

1 MEMS scanner
111 first frame
112 second frame
113 third frame
121a, 121b torsion bar for X axis driving
122 first torsion bar for connection
123 first torsion bar for wiring
124 second torsion bar for connection
125 second torsion bar for wiring
126a, 126b first torsion bar for Y axis driving
127a, 127b second torsion bar for Y axis driving
131 first mirror
132 second mirror
140 driving source part
141 coil
142a, 142b magnet for X axis driving
143a, 143b magnet for Y axis driving
144 wiring

1. A driving apparatus comprising:
a first base part;
a second base part;
a third base part;
a first elastic part that connects the first base part and the second base part;
a second elastic part that connects the second base part and the third base part;
a first driven part that is supported by the first base part to be driven; and
a second driven part that is supported by the third base part to be driven.

2. The driving apparatus according to claim 1, wherein
the driving apparatus further comprises an applying device that applies, to the second base part, a driving force for driving the first driven part and the second driven part,
the first driven part is driven by the driving force that is transmitted from the second base part via the first elastic part,
the second driven part is driven by the driving force that is transmitted from the second base part via the second elastic part.

3. The driving apparatus according to claim 1, wherein
the driving apparatus further comprises an applying device that applies, to the second base part, a driving force for driving the first driven part and the second driven part,
the second base part is driven to rotate in a first rotational direction by the driving force,
each of the first base part and the third baser part is driven to rotate in a second rotational direction that is opposite to the first rotational direction due to the rotation of the second base part,
the first driven part is driven to rotate in the second rotational direction due to the rotation of the first base part,
the second driven part is driven to rotate in the second rotational direction due to the rotation of the third base part.

4. The driving apparatus according to claim 1, wherein
the first driven part and the second driven part are driven in a same or synchronized driving aspect.

5. The driving apparatus according to claim 1, wherein
the first driven part and the second driven part are driven to rotate in same rotational direction by same rotational angle in synchronization with each other.

6. The driving apparatus according to claim 2, wherein
the driving apparatus further comprises an applying device that applies, to the second base part, a driving force for driving the first driven part and the second driven part,
the second base part is driven to rotate in a first rotational direction by the driving force,
each of the first base part and the third baser part is driven to rotate in a second rotational direction that is opposite to the first rotational direction due to the rotation of the second base part,
the first driven part is driven to rotate in the second rotational direction due to the rotation of the first base part,
the second driven part is driven to rotate in the second rotational direction due to the rotation of the third base part.

7. The driving apparatus according to claim 2, wherein
the first driven part and the second driven part are driven in a same or synchronized driving aspect.

8. The driving apparatus according to claim 3, wherein
the first driven part and the second driven part are driven in a same or synchronized driving aspect.

9. The driving apparatus according to claim 2, wherein
the first driven part and the second driven part are driven to rotate in same rotational direction by same rotational angle in synchronization with each other.

10. The driving apparatus according to claim 3, wherein
the first driven part and the second driven part are driven to rotate in same rotational direction by same rotational angle in synchronization with each other.

11. The driving apparatus according to claim 4, wherein
the first driven part and the second driven part are driven to rotate in same rotational direction by same rotational angle in synchronization with each other.

12. The driving apparatus according to claim 6, wherein
the first driven part and the second driven part are driven in a same or synchronized driving aspect.

13. The driving apparatus according to claim 6, wherein
the first driven part and the second driven part are driven to rotate in same rotational direction by same rotational angle in synchronization with each other.

14. The driving apparatus according to claim 7, wherein
the first driven part and the second driven part are driven to rotate in same rotational direction by same rotational angle in synchronization with each other.

15. The driving apparatus according to claim 8, wherein
the first driven part and the second driven part are driven to rotate in same rotational direction by same rotational angle in synchronization with each other.
